(19) United States
(12) Patent Application Publication
(10) Pub. No.: US 2011/0250580 A1
(43) Pub. Date: Oct. 13, 2011

(54) Learning System for Digitalisation of An Educational Institution

(75) Inventor: Srivastava Sandeep, New Delhi (IN)

(73) Assignee: IYC WORLD SOFT-INFRASTRUCTURE PVT. LTD., New Delhi (IN)

(21) Appl. No.: 13/122,620

(22) PCT Filed: Oct. 6, 2009
(86) PCT No.: PCT/IN2009/000551

§ 371 Date: Jun. 13, 2011

(30) Foreign Application Priority Data
Oct. 6, 2008 (IN) 2307/DEL/2008

(51) Int. Cl. G09B 7/00

(52) U.S. Cl. 434/362

(57) ABSTRACT

A system that catalyses world-class quality in education in any institutionalized setting, howsoever small and formal or informal by integrating all processes, transactions, resources and controls (such as security of children, emergency response) for an educational organization, gated educational communities such as schools, dispersed private learning communities of kinships/professional organizations/neighborhood/any other source of association, or virtual self-learning communities. The system includes tools and devices which enhance the process, content and context of learning. Intelligence-embedded, self-help tools and appropriate macro- and micro-inputs to the community members, as well as the individual learners within, enable comprehensively unaided instruction and learning context at the community level. All academic subjects in a curricular framework up to a higher secondary level, across a plurality of nations, are covered.

### FIELD OF INVENTION

The present invention relates to a learning system for digitalisation of an educational institution. The institution may be formal as well as informal, small as well as big, and it helps educational institutions to cope with the demands and opportunities of the emerging knowledge society. The system also relates to technological, process, content and resource ‘infrastructure’ for world-class quality in management and delivery for organizations (formal as well as informal) engaged in education.

### DESCRIPTION OF THE RELATED ART

U.S. Pat. No. 7,210,938 discloses a system and a virtual school application that are useful not only for online users; but can also be used to connect standalone users and networks of users to access and update a virtual school database. Moreover, the system comprises of any biometric device which can be used in order to verify the identity of a user of the system. However, this document relies on online tutors who are available physically to answer each and every query on request by the learners and puts a limit to the extent to which it can support learners—geographically, timelines, quality at any given time, capacity to support at any given time etc. The present invention creates a self-tutoring system which does not necessarily requires a physical tutor to answer each and every query by the learners and thus it's boundlessly scalable across dimensions using increasing intelligence embedded in the system.

U.S. Pat. No. 7,281,219 relates to a method of displaying a blended learning experience, that comprises the steps of defining degrees of elements in the learning zones, defining a percentage of formal learning for each zone, constructing a circular display having wedges corresponding to the zones with each wedge having an inner sub-wedge, wherein the angular width of each wedge corresponds to the degrees and the radius of each sub-wedge corresponds to the percentage of formal learning, and displaying the circular display on a computer monitor or hardcopy printout. The present invention is a complete learning platform by itself unlike the U.S. Pat. No. 7,281,219 which is a framework used for blended learning. The present invention is an innovative packaging of tailored processes and tailored content (already complete to an extensive level for K-12) into one online education platform.

U.S. Pat. No. 7,360,158 relates to an educational tool that assists users in better understanding of complex systems. The tool also provides for graphically representing components of a complex system. Moreover, when the user selects a displayed component of the system, the tool provides educational information, relating to the selected component. A user may then “drill-down” further into the display of the system in order to obtain. additional information regarding the selected component.

This document discloses a software platform/tool to which content providers can add their content to deliver the final educational platform, unlike the present invention that is an integrated system with both process and content packaged together by the service provider as the basic model though users can create and share content.

U.S. Pat. No. 6,688,891 relates to a method and apparatus for effectuating a true electronic collaborative k-12 education process model, bringing together parents, student, teachers and school administrative staff (principals, counsellors, district, state, national and international education administrators and other professionals) to form a Team Education Community (TEC) employing a collaborative approach to virtually all aspects of learning and teaching. A relatively lightweight portable computer-based device that includes a touch-screen display, a biometric identification security device for certification of actions in the collaborative process, a built-in speaker and microphone for audio recording and playback and an array of specialized collaborative, interactive, localized tutorial content, communications software and other education specific applications.

This document has computing and input/output device at the user level as an integral part of the system while the present invention is computing and input/output device independent except for a ‘personal card’ needed in formal institutional setting which is not necessary for private learning communities and a large combination of computing and input/output devices could do the job. This document teaches blended learning with school and home enabled much like the present invention but the present invention is different as it redefines the fundamental nature of the ‘blending’ i.e. in the present invention the students and parents are very differently enabled to be independent learners i.e. self-tutoring for students and micro-inputs and analysis to parents for most effective self-support to their children. Further, the present invention is applicable and appropriate for informal as well as very small educational communities.

U.S. Pat. No. 6,760,748 relates to a system that provides facilities for fully or partially automating the giving and grading of quizzes, class attendance, roll keeping, grading of homework and other routine paperwork associated with monitoring student progress and record keeping. The electronic classroom includes a central computer and display at the teacher's desk, a plurality of terminals at desks of individual students and network connection between the central computer and the terminals. The terminals may range in complexity from a simple dedicated keypad with rudimentary display, to a hybrid version of a calculator/terminal with numeric and function keys, a rudimentary hand-held computer with a full keyboard and single or multi-line display, having a number of other possible functions such as those of a calculator, typewriter, organizer, appointment diary, phone directory, thesaurus, and dictionary, up to a full-fledged personal computer capable of operating in a stand-alone mode. The student terminals may be fixed in the classroom, or may be carried by students as portable devices with numerous possible ranges of applications outside a classroom context. Unlike this teaching of this document, the present invention is a 360° Learning System with extensive institution-wide enablement of content and processes and for all the stakeholders.

U.S. Pat. No. 6,760,748 is based on teaming up students in a more specific sense to measure learning attainment. The present invention also secures team up for students but it's essentially for much broader learning gains of which team assessments are natural component. In the present invention, the team up could also be diverse. Students, parents, teachers, any other authorized users/guest (dynamically authorized by the learners/users at that given time) could team up for a collaborative effort.

US publication No 20050019741 relates to a system and method to manage a cyber institute. In managing a cyber institution, the method verifies an accurate attendance and registration by comparing fingerprints or iris of the eyes. The method of scholastic management of the cyber institution is done by calculating automatically the true attendance of the cyber class by student's individual ID by a host computer to prevent wastage of human resource and operating cost by a more accurate and economical managing system. Unlike this document, the present invention is not at all focused on cyber teaching or matters related thereto as well as not so particularly focused on the growth of pre-school students in the manner reported in the above publication.

Publication No. CN1595396 relates to a self-defining nonlinear electrical interdynamic teaching system, which belongs to electrical education, IT and the software technique fields. Unlike the present invention which is a comprehensive educational solution for blended learning, this Chinese publication is restricted to particularly preparing for the entrance examination in a particular set of subjects/topics to best address the peculiarities of the subjects/topics addressed. The primary goal of the present invention is to enhance the foundations of learning/knowledge of the students in a far larger context and to limits/dimensions significantly determined by the students.

U.S. Pat. No. 6,813,474 provides an Educational Content Communications System (“ECCS”) designed to create, process and manage educational content within a school, within and between a system of schools, within and between a community of schools, and within and between third-party providers of educational content. The present invention, on the other hand, is focused on a lot of interactivity and collaboration around the content that is extensively build to match the curricular needs of the learners; extensive curricular content is an inbuilt feature and the use of the same creates a content for information and interaction among the various users (e.g. teachers, parents, peers, principal, tutor).

US Publication No. 20080065405 relates to a method for managing sub communities within an online business community.

U.S. Pat. No. 6,505,031 relates to a virtual school environment for allowing a plurality of teachers from a plurality of schools to communicate with their students or their students' parents over a computer network.

US Publication No 20020177109 relates to a system and method for creating, processing and managing educational content. More specifically, this invention relates to an Educational Content Communications System (“ECCS”) that enables students, teachers, parents, and administrators (including staff) to access, share, create, input, manage, store and/or deliver educational content.

US publication No 20010049087 relates to an interactive on-line learning environment combining real video connections and chat rooms with document libraries of the student's own work and the teacher's home work assignments. The present invention is an extensive learning and process portal for institutions.

The article entitled “Microsoft 360 Degree Learning Program” describes a program which aims at creating an effective learning and teaching environment, with a special focus on mobile learning as a means to enhance the interactions between the teachers and the students. It is a public portal based learning system where access and rights are not governed by the school or institute. The present invention also builds institutional portals which form the entry point of using the world of educational processes and content but the access to the portal is controlled by the institute and made available to bonafide members of the institutions.

The article entitled “Schools learn about the benefits of biometrics” describes the applications for biometric technologies in the field of education. The article describes usage of biometric technology for administrative purposes but not for the analysis of a child's progress in the schools, a key goal of the use of biometrics in the present invention. One of the key purpose of using biometrics in the present invention is to automatically and assuredly authenticate the log-in of students in the learning processes and resources and record their responses, inputs and actions for immediate and analytical reasons. Expectedly, in the present invention, biometrics is just one feature of the device and the device performs many more functions besides biometric identification and attendance.

The article entitled “Biometrics in Online Assessments: A Study Case in High School Students” describes the use of a prototype online assessment system with biometric recognition capabilities applied to evaluate basic knowledge in a High School. The prototype system represents a first approach to identify remote students in online assessment to solve the well known problem. In the present invention, the biometric authentication is primarily aimed at in-class and in-school usage. Biometric recognition capability for remotely authenticating the identity of user students is not a critical issue given the blended learning environment of the invention, both in formal or informal setting, in which there are longitudinal and multi-dimensional records for corroboration with students performance in out-of-school online assessments.

The debate on disconnect between the education system and the socio-economic imperatives and opportunities is a few decades old now. The ‘systemic’ response to the same has been the rapid growth of supplementary education providers, across the globe to address the ‘deficiency’ in the system. Apparently, it has failed to provide a real solution. Unfortunately both, the mainstream system of schools and the supplementary education system operating on most students are not delivering what is expected of them.

The emergence of the knowledge society has aggravated the need for a far reaching change in the educational system because the technological, political, social and economic changes are now writ large across the world and the educational system is still ‘serving the demands of the industrial society’.

An alternative infrastructure and model to deliver education that is far more customized and dynamic to the needs of the learners and communities to reflect the characteristic pace and sweeping span of the knowledge society's emerging global village needs to be explored and secured.

Information technology (I.T.) is perhaps the central driving force of the emerging knowledge society but it has been very peripherally harnessed in and around the education system—both mainstream and supplementary. And the deployment of I.T. in education has followed inside-out approach (using I.T. within the educational institution) while almost completely ignoring outside-in approach (impacting the education system by using I.T. for making appropriate changes in the ecosystem of the education system e.g. homes of students, teachers; involving parents, collaborations among students and teachers outside school).

The article titled “Putting Toowoomba first community based portal” talks about developing a community portal for the city of Toowoomba for free interaction between the community members, to provide information on the city, to provide a forum for the community

The article titled “Pay Lebar Online portal” talks about a portal is a community portal for the residents to interact, carry out online transactions and be in touch with the latest developments.

The above mentioned citations are ‘pure’ educational softwares build for and focused on the established mainstream institutions such as schools (and supplementary education institutions at best) and none of them explicitly or implicitly seek to offer alternative learning system which is anchored outside the mainstream educations system. All of these anyway don't address the informal sector, the private learning communities or kinship, neighbourhood or the members of an organisation.

On the contrary, the present invention also seeks to explore completely uncharted territory for affecting educational revolution for quantity and quality across the globe by introducing educational delivery goals to organizations where the primary goal of their existence is not education (e.g. family, extended families, neighbourhoods, most kind of organisations.

The present invention provides a new technological platform that enables some type of communities of people to take charge of education of their members and their children without diluting their primary goal as a community such as ‘economic well being’ for business organizations. It also provides to connect the mainstream educational institutions to the ‘community private learning systems’ to create the perhaps the most effective educational system which includes both the formal institutions and the home and social space of the children (through the community eduportal).

The present invention most effectively addresses the issue of handholding the much needed transformation in the current educational system and institutions and offer one-stop I.T.-based infrastructure for educational institutions that most effectively complements the physical and manpower resources of the educational institutions. It also aims to innovatively harness I.T. outside of the education system by enabling communities of people to offer education to their members and their families and co-opt the mainstream education system to create the most comprehensive, dynamic and sensitive educational system possible.

The present invention is provided with a component of virtual schooling but all the tools and processes of virtual schooling are modified for the 360° learning system by integrating all the stakeholders in the education of a learner and thus it's rooted in substantive interactions on the ground at the level of the school or families or other tutorial helps. In fact, nothing is exactly virtual in the present invention as it is a highly blended learning environment. Further, the present invention redefines the learning resources by offering self-tutoring tools which redefine the power of virtual schooling and make e-tutoring a really effective solution to personal tutoring. The present invention is typically implementable in phases that best suit the milestones and capacity of the educational institutions.

### OBJECTS OF THE INVENTION

A primary object of the present invention is to provide a system that enables a comprehensively digital educational institution covering all processes and contents.

Another object of the present invention is to provide a system that comprehensively digitalises all processes of the institute.

Yet another object of the present invention is to provide a system that comprehensively digitalises all content.

Still another object of the present invention is to provide a system that comprehensively digitalises an educational institution in a seamless, integrated software and hardware backbone.

Another object of the present invention is to provide a system that comprehensively digitalises an educational institution in a way that all the interfaces are self managed by the respective process-owners.

Yet another object of the present invention is to provide a system that comprehensively digitalises all routine processes of a teacher, students, staff, principal, alumnus, visitors and authorized guests.

Still another object of the present invention is to provide a system that comprehensively enables inter-institutional collaborations as well as collaborations among the institutions within the same ownership (government or private).

Another object of the present invention is to provide a system that comprehensively enables an institution to widely share its digital resources with others, including other institutions as well.

Another object of the present invention is to provide a system that most appropriately and comprehensively links a number of resources such as but not limited to academic, administrative, public interface and inter-institutional processes and resources.

Yet another object of the present invention is to provide a system that comprehensively enables an institution to digitally participate in collaboration for pooling educational resources on to a different/independent platform.

Still another object of the present invention is to provide a system in which routine processes and content for access is comprehensively digitalised across all appropriate media that include such as but not limited to Text SMS, Multi-media SMS, remote live video, PDA integration, GPS.

Still another object of the present invention is to provide a system that comprehensively enables the most optimal utilization and sharing of all the physical resources of an institution for its own use or for collaboration with other institutions or individuals.

Another object of the present invention is to provide a system that enables an institution to deploy remote lecturing/counselling by teachers or guest lecturers and automated step-wise assessment, where practical, of their assignments to students.

Yet another object of the present invention is to provide a system that dramatically reduces the total cost of operation/service for institutions as well as to students/parents.

Still another object of the present invention is to provide a system with the capability to secure life-transforming ability in the educational system so that even a first-generation learner, in fact any first-generation learner, can realize his/her informed socio-economic goals commensurate with his/her effort and motivation.

Another object of the present invention is to provide a system that ensures world-class tools and resources for every teacher for self development as well as pedagogical ends.

Yet another object of the present invention is to provide a system that galvanizes the next-generation portals around educational system.

Still another object of the present invention is to provide a system which uses non-proprietary hardware and non-proprietary access software environment for users (individual as well as institutional); non-proprietary in the sense of the system supporting the use of low-cost, popular system software and hardware design that is widely available for manufacturing.

Another object of the present invention is to provide a foolproof auto-identification system that ensures secure identity and users rights of access to the best extent possible.

Yet another object of the present invention is to provide independent learning system for every subject such as but not limited to math, physics, chemistry, biology, accountancy, geography, English.

Still another object of the present invention is to create a 360° learning system.

Another object of the present invention is to provide a system with a self-checking diagnostic system for various subjects as part of the self-tutoring or self-coaching system or standalone.

Yet another object of the present invention is to provide a system with a wireless campus backbone starting with a biometric attendance at some point around the gate of the school, period-wise biometric attendance registration in each period, controlled/secure ability to analyze and provide with patterns.

Still another object of the present invention is to provide a system that forms an organic school-home continuum and between the two the entire supplementary education becomes redundant without any loss to the learning resources/opportunities to the students.

Another object of the present invention is to utilize biometric technology to gain insight into the progress of the child.

An object of the present invention is to provide an system that includes further an online learning system that offers world-class educational content and resources to students customized to some specifications (a necessary condition for content to be really effective) for users.

Another object of the present invention is to provide an online learning system for ‘closed, real, defined’ communities.

Still another object of the present invention is to provide an online learning system best harnessing the 360° Learning System (which is the subject matter for Indian Patent Application No. 1315/DL/2008 filed on May 30, 2008) by applying it in a community which is closely linked and interactive.

One further object of the present invention is to provide a new online learning system that also harnesses the strengths of the mainstream education system by ‘backward integration’ of community learning systems to the mainstream institutions.

Another object of the present invention is to provide an online learning system that also supports the primary goals of the user communities.

Another object of the system is to provide an alternate to the critical re-inforcement support needed at home by the students (especially in case of parents who are hard-pressed for time or those not academically capable of re-inforcing the children as in the case of first-generation learners).

Still another object of the present invention is to provide an online learning system that creates a platform for competitive benchmarking across communities to give as realistic a feedback to users as possible on their relative merit on a ‘global’ and ‘local’ level for each community.

One more object of the present invention is to provide an online learning system which helps create ‘self-tutoring family units’ within the communities by bring together an innovative technological platform and content that educates all members of the communities.

### SUMMARY OF THE INVENTION

Accordingly the present invention relates to, a system that integrates multi-format learning and education into routine personal and professional lives. The system comprises of different tools which enhance the process of learning. Such tools are for self tutoring, self checking or diagnostic test bed, all subject learning system and tracking the progress of the student. Through the use of biometric and wireless technology, the system provides extensively comprehensive insight into the complete learning and administrative context of the students while in school and partially at home too.

In a preferred embodiment the invention provides a learning system for digitalisation of an educational institution comprising: a digital identification system (which is preferably wireless, biometric and RFID integrated), server and nodes in an intranet in the institution; an internet-based server and bandwidth infrastructure; and access devices like PDA, PCs, and laptops, and identity assurance and management system for ensuring automated attendance / presence of students (teachers, staff and any other guest visitor, if required), and for mapping the students identity to the intranet in the institution (to seamlessly and organically participate in the debates, Q & A, polling etc. in the class or the school) and the institutions internet-based portal (to seamlessly and organically link the tasks and exchanges in the school with tasks, exchanges outside the school). Of course the intranet data and intemet portal data are synchronized.

Another embodiment of the present invention provides a system with means for integrating multi-format learning and education into routine personal and professional lives and further tools for self tutoring, self checking or diagnostic test bed, all subject learning system and tracking the progress of the student. Through the use of biometric technology, the system provides extensively comprehensive insight into the complete learning context of the students while in school and partially at home.

Another embodiment of the present invention provides an interactive learning tool that significantly focuses on K-12 students as well as teachers and parents and is customized so that the content is largely tailored for the actual books used by the students, extensively covering the entire k-12 curriculum, based on multiple formats such as but not limited to animations, software applications, 360 degree.

In another embodiment of the present invention the system is based on real identities for an institution and each institution's database populated only by authorized users of the institution.

In another embodiment of the present invention the system provides for online collaboration among peers, teachers, parents, tutors and other authorized users of the system as well as in-person classroom interactions and interactions beyond the class but in the institution.

In another embodiment of the present invention the system provides for online collaborations among peers, teachers, parents, tutors and other authorized users of the system to collectively arrive at the solution of an assignment or debate a question/query/topic etc.

Another embodiment of the present invention provides the system adapted for comprehensively digitalising all processes of an educational institute that include such as but not limited to administrative, learning, admission, alumni, fillings/reports for governments, alumni relations, inter-school exchanges, intra-society/government department exchanges and reporting, online, offline. The system digitalises comprehensively all content that include such as but not limited to syllabus, class notes, assignments, examination papers, progress reports, various listing such as books in library, notices, fees.

In another embodiment of the present invention the system also comprehensively digitalises all routine processes of a teacher that include such as but not limited to marking attendance, ‘copy checking’ for assignments well beyond objective-type questions, communication with parents and colleagues, notices, event planning and management, progress reporting, syllabus, timetabling, class room lecture content and notes, homework/assignment management, queries from students and parents.

In another embodiment of the present invention the system also comprehensively digitalises all routine processes for a student that include such as but not limited to notifying presence or absence at any instant of time or place, class notes and lectures, homework and its submission upon completion, access to various facilities in the school, availing of the various services in the school.

In another embodiment of the present invention the system also helps the staff by comprehensively digitalising all routine processes for a staff that include such as but not limited to accounts, library, fees, payroll, book shop, hostel, mess, reception/front office, stores and purchase.

In another embodiment of the present invention the principal or the head of the institute also benefits from the comprehensively digitalised routine processes that include such as but not limited to extensive MIS on administrative status and approvals, extensive MIS of learning related status and approvals, analytical reports on teachers' and staff's performance, query and interactions with parents and others.

In another embodiment of the present invention routine processes of an alumnus and visitors are also comprehensively digitalized in the present system that include such as but not limited to registration, exchange among themselves, exchange with teachers and students, community services such as job search, business links, product promotions, their access rights on the premises and the institutes portal, record of their interactions/exchanges, evaluation of their exchange/contributions, communication/notices for them.

In another embodiment of the present invention the routine processes and content for access is comprehensively digitalised across all appropriate media that include such as but not limited to Text SMS, Multi-media SMS, remote live video, PDA integration, GPS.

In another embodiment of the present invention the system has in-built zones of control for students with respect to the time period of the timetable, level of the class, gender, special interests/rights and any violation of the same is reported automatically to the concerned teacher or staff.

In another embodiment of the present invention the system very significantly enables entrepreneurship in school education by providing world-class processes, content resources and community, anywhere and anytime (given access to Internet), to kickstart quality education at a very low cost.

In another embodiment of the present invention the system very significantly enables entrepreneurship in school education by enabling a not so qualified and trained person to be the facilitator teacher in schools.

In another embodiment of the present invention the system enables individual families as well as various kinds of communities to take up the academic development of their children by themselves.

In another embodiment of the present invention the system revolutionizes the content and community resources of first-generation learners by offering self-tutoring educational platform which does not need re-enforcements from the family at home (being first-generation learners, the families are not capable of academically supporting the children's learning activities at home).

### DESCRIPTION OF THE PREFERRED EMBODIMENTS

The present invention, provides a learning system. for digitalisation of an educational institution comprising of digital identification system (preferably wireless, biometric, RFID too), server and nodes in an intranet in the institution, internet-based server and bandwidth infrastructure and the access devices such as PDA, laptop, PCs. All the hardware extensively interact in synchronous and asynchronous mode. The application software is an integrated software with. certain ‘offline’ components placed on the institutions' intranet and online web-based software besides the device specific softwares (such as the biometric softwares attached to the hardware) and system software such as Windows and Linux.

The system also provides an interactive learning tool which significantly focuses on K-12 students as well as teachers and parents and is customized so that the content is largely tailored for the actual books used by the students, extensively covering the entire k-12 curriculum, based on multiple formats such as but not limited to animations, software applications, 360 degree.

The present invention intends to provide the next-generation of educational institutions (as the society transits from an industrial society to knowledge society) to best integrate with the opportunities and imperatives of the knowledge society. In a way it represents the roadmap of transformation in education institutions across the globe. The goal of the transformation in the educational institutions, at all levels, across the globe, with the achievement of near 100% enrolment of all children in the ‘2-25 years age’ into the emerging multi-format formal education system and securing that every one of them receives quality education (‘quality education’ is a key target and defined later in this application)—everyday, everywhere, 24X7. The invention also brings about a revolution in continuing/ adult education and seamlessly integrating learning and education into the routine personal and professional lives.

Quality education has defied a widely acceptable definition. For the purpose of this invention it's defined as an education system that has transformational capability even for the first-generation learners (students whose parents did not have a formal education up to the level of any public examination) such that all learners (all children across the globe, irrespective of their social, economic and cultural context) can grow skilled, knowledgeable and confidently motivated to realize their informed socio-economic dreams in their own lifetime so that no human being left behind.

The present invention system is based on real identities for an institution and each institution's database populated only by authorized users of the institution. The system galvanizes the next-generation portals around educational system as the pivot of the dynamic-real-identity-based authenticated log-ins and integrating health, entrepreneurship and community services as integral extensions of the online educational system.

To best suit the reach and lowered cost of quality education across the globe, the present invention provides multiple formats, layers/steps of I.T. infrastructure for institutions.

The present invention is a broad framework for the institutional design of schools and colleges in the emerging knowledge society and it may not be deployed ‘as it is’ or even in significantly similar form. The aforementioned reference to ‘schools and colleges’ do not imply any high resemblance to the current schools and colleges. A particular school or college may harness only a part of the framework at any point in time.

Self-tutoring in the present invention helps children to learn on their own by trying and retrying, unlike online tutoring systems where the students are taught a topic and questions are handed down by the teacher (there is limited expectation of self-discovery and question generation). Self-tutoring is driven by self-enquiry and encourages learners to ask the right question to such as but not limited to mentors/tutors/teachers/parents/friend/any other authorized person (a bottom-up or lateral process of learning).

Several issues related with the cyber learning or online tutoring do not come up in the present invention. Due to the blended learning there is a correlation between the physical and online learning, thereby a particular pattern of the student's learning process is seen. The blending in the present invention is technically achieved through online collaboration from peers, teachers, parents, tutors and other authorized users of the system as well as in-person classroom interactions and interactions beyond the class but in the institution.

The present invention also uses team interactions among learners as a means of collaboration among the students and the display of individual efforts to the teacher/tutor/authorized people to assess the level of collaboration achieved among them.

For this purpose there is provided an online learning system comprising of an online portal with 360° learning system customized to various degree for each registered user community. This system has a typical technical infrastructure to host and manage the data on the net. Apart form this, the system has the mechanism to push and pop the data from the online server through internet connected devices/mobile devices like mobile and WAP enable devices. The entire system is enabled in such a way that it can work as a portal as well as it can be plugged on any web site/portal. The entire system is working on a centralized ‘n’ tired architecture.

This ensures greatest level of benefits to the student's communities identity and common good and the best possible benefits to cater to the differences in the needs and wants of individual families and their members.

It enables a platform for ‘common approach’ towards educational resources and methodologies irrespective of the actual schools used by the students in the community. It provides a new technological and content platform that offers educational resources to communities of people through customized educational portals for each community i.e. private learning systems for communities. The system uses existing business, social, filial, political, private networks of people to offer comprehensive virtual educational processes and resources so that they can effectively supplant the supplementary educational resources and over time create bottom-up demand for change in the mainstream educational system by backward integration of the community learning platforms into the mainstream education system.

Each community is restricted in access to the families in the respective communities. This is done by having a community level access and security system using the role, right and process permission on the virtual internet based platform which resides on the internet. Virtual internet based platform comprises of at least one web server and at least one client computer including server and client processors for executing server and client input and output elements for communication between the said server and client computers. At least one server computer further includes a user database for storing unique identification information related to users/Community information, and it has the following; among other features:

a wide range of curricular and co-curricular content pooled together for the community as a whole, that resides on a centralized file server/server on the internet with restricted/authenticated access to various users/communities.

exchange/collaboration, through various exchange/collaboration tools residing on the centralized web server that allows users to create/access closed/public groups and access/modify/post their opinion'on the net.

specially developed and tailored content, residing on at least one web based file server/server, needed by the community and tailored exchange/collaboration opportunities (a very important and potent example of special content is the case of first-generation learners among students who cannot get any re-inforcement at home in their education and also cannot secure quality supplementary education. Academically weak or specifically gifted children are another case in point because they need special support and empathy which may not come from their families alone).

sharing, celebrating, recognizing individual and group accomplishment using database enabled web server to store the data pushed by authenticated users.

competitive benchmarking for larger competitive exams using benchmarking system comprising of one web server and one database server to store the responses of the user and one reporting system to generate the benchmarking report based on the data residing on benchmarking system.

involved and effective counseling and mentoring (because of the common context of being part of a community) Using tools like chat, instant messaging and discussion board comprising: at least one server computer and at least one client computer including, a server and client processors for executing server and client input and output elements for communication between said server and client computers. Also it includes at least one server computer and a user.

database for storing posted information related to users and publishing permitted information on the net.

In fact, diverse types of communities will find the present invention very useful and an illustrative listing is given hereinunder:

a) Families of employees in business, social, autonomous, inter-governmental and government organizations.

b) CSR of business organizations interested in redefining the reach and impact on the lives of their beneficiaries.

c) Village, county or any organized neighbourhood.

d) Extended families trying to pool their collective strengths and giving their children a sense of unified kinship and values.

e) Beneficiaries of NGOs in education, health and entrepreneurship and

f) Families interested in home schooling their children while maintaining the highest academic standards and without greatly compromising on their professional and other commitments.

The invention also addresses a newly emergent gap in the educational system—the ‘typical slower than expected’ institutional response of our schools and colleges to the changing demands in professional life, social and political organisation, individual lifestyle and intra-family obligations and chores. The solution showcases the resources, methodologies and tools that must be used by ‘society's educational institutions’.

Non-community members' (individuals whose communities have not joined the online portal at that point of time) can only avail of a limited set of services through a single, common platform available on the online portal.

A very significant part of the online portal is the ‘backward integration’. This is facilitated by connecting the actual schools and colleges of the children to the online ‘space’ of the respective registered communities that resides on a centralized server on the internet with restricted/authenticated access to various users/communities. It is also be possible to connect actual individual teachers in the schools of the children with the online spaces of the respective registered communities by providing them controlled restricted access to the space/database. The intranets of the various educational institutions, irrespective of their operating environment, are able to effectively communicate and collaborate with the eduportal of the respective communities to which their students belong.

The present invention also offers a system for ‘closed, real, defined’ communities by providing them one unique identification number and controlled access on the online system using diverse access devices and extensive multi-media and multi-platform integration.

The present invention provides a system that also supports the primary goals of the user communities e.g manpower skill development for the employees of a business organisation as an user community by providing educational solution to the each member of the community as well as their families.

Instant feedback or communication with various peers within the context of the course's content is not usually opposable. The inability of users to interact with their peers while reading through material is a detriment to online learning. These problems are overcome by the present invention which provides systems and methods for providing collaborative services in a child-safe way by limiting access to each eduportal to clearly identified community of users. Thus, the online course is no longer a static experience where the user simply reads text or listens to audio for example, but is one where the user is freely interacting, communicating or collaborating with others who are also associated with or are currently taking and viewing the course. This enhances the learning experience of the user.

Technically the system is enabled in such a way that it can run on one web server computer and at least one client computer for communication between the said server and client computers. The said server computer further includes a user database for storing unique identification information related to users like students, teachers, parents, administrators and communities and an content database/space for storing content that is accessed by said the users; user access means for allowing users to register and access content. User database and said content database reside in at least one database server. User can fetch/push the information on the web server through WAP enabled devices/SMS devices. The entire system is innovatively designed in such a way that it does not transfer massive data over the net all the time during user's stay on the portal. Once the environment is set, it only uses the net connectivity to validate the user and the logged in users also replay the downloaded content as many time as they want or are allowed.

A system provided by the present invention, that comprehensively redefines the class room transaction—from top down ‘lecture’ by teachers to lateral ‘query and response’ among teachers and students where students come well-read on the broad subject/topic of discussion.

The system also significantly redefines the inputs by the teachers—top down and primarily academic to primarily bottom-up specific academic and personal counseling—almost 100% of the teachers' time to be spent face to face with students, individually or in groups, inside or outside the class room.

The present invention also provides the I.T. hardware as well as software, at the generic level, for the entire institution to be world-class in the quality of education, safety and security of the students, efficiency and paperless operation. A layout of an IP-based extensive, hardware and software architecture that is low cost, comprehensively integrated, extensively digital, least proprietary from users' access point of view, single user-ID driven, seamless accessible through standard IP-enabled devices. The present invention specifically builds on non-proprietary hardware and user access interface so as not to create any external barrier to what is supposed to be a mass education platform.

The present invention also provides a device capable of providing location information of child being tracked. The granularity of the location information may vary from a few meters to a few hunched meters depending upon the technology being used. The service can provide precise details e.g. when the child enters the school bus, an RFID scanner could detect the device carried by the child and communicate the information to a backend server via the wireless network The information about the childs location could be further augmented by tracking the childs device by using multiple device/network technologies like cell Id tracking, GPS or Assisted GPS tracking. The RFID scanners could be placed in multiple locations in the school to always provide the updated precise location information of the child within the premises of the school.

This device could also be enabled to carry out mobile commerce transactions. It would be possible to link an account like a credit card, bank account or a cash card to the mobile device enabling the child to do small transactions using the mobile phone. The transactions could be limited to a particular amount per month in order to avoid misuse. Various technologies like an on device application, SMS verification, Near Field Communication system could be used to carry out the mobile commerce transactions with a secure verification mechanism. This would enable the child e.g. to go to the cafeteria and pay by swiping the mobile device at the payment counter—the device would display the amount to be paid and the child would accept by entering a 4 digit security code.

This device would be capable of enabling the child in tracking the homework, school events and in the learning process. A mobile application on the device would provide him the requisite information under various tabs. The child could also choose a particular subject and course material could be displayed in a text or animated format. The child can also get options to test his/her knowledge by means of objective type questions. If needed the service could be further augmented by an on line tutoring option whereby the child could press a tab within the user interface of the application and could be connected to an on line tutor via a voice over IP or circuit switched call.

The present invention provides a system that is capable of branding all the facilities from any vendor as the institutions own services or co-branded within the portal of the institution.

The present invention comprehensively digitalises all processes of an educational institute that include such as but not limited to administrative, learning, admission, alumni, fillings/reports for governments, alumni relations, inter-school exchanges, intra-society/government department exchanges and reporting, online, offline. The system digitalises comprehensively all content that include such as but not limited to syllabus, class notes, assignments, examination papers, progress reports, various listing such as books in library, notices, fees.

Besides the processes of school the system comprehensively digitalises all routine processes of a teacher that include such as but not limited to marking attendance, ‘copy checking’ for assignments well beyond objective-type questions, communication with parents and colleagues, notices, event planning and management, progress reporting, syllabus, timetabling, class room lecture content and notes, queries from students and parents. It also comprehensively digitalises all routine processes for a student that include such as but not limited to notifying presence or absence at any instant of time or place, class notes and lectures, homework and its submission upon completion, access to various facilities in the school, availing of the various services in the school.

It also helps the staff by comprehensively digitalising all routine processes for a staff that include such as but not limited to accounts, library, fees, payroll, book shop, hostel, mess, reception/ front office, stores and purchase.

The principal or the head of the institute also benefits from the comprehensively digitalised routine processes that include such as but not limited to extensive MIS on administrative status and approvals, extensive MIS of learning related status and approvals, analytical reports on teachers' and staff's performance, query and interactions with parents and others.

Routine processes of an alumnus and visitors are also comprehensively digitalized in the present system that include such as but not limited to registration, exchange among themselves, exchange with teachers and students, community services such as job search, business links, product promotions, their access rights on the premises and the institutes portal, record of their interactions/exchanges, evaluation of their exchange/contributions, communication/notices for them.

The routine processes and content for access is comprehensively digitalised across all appropriate media that include such as but not limited to Text SMS, Multi-media SMS, remote live video, PDA integration, GPS.

Inter-institutional collaborations as well as collaborations among the institutions within the same ownership (government or private) are provided by the present invention enabling an institution to widely share its digital resources with targeted others, including other institutions as well. The institution also enabled to digital participate in a collaboration for pooling educational resources on to a different/independent platform.

Most effective optimization of the utilization and sharing of all the physical resources of an institution for its own use or collaboration with other institutions is enabled by the system.

The inter-school collaborations include such as but not limited to for contests, sharing of notes/assignments/question banks/syllabus/timetables/event management/library resources, remote lecturing or shared lecturing across institutions, remote copy checking for assignments/tests/examinations.

Deployment of remote lecturing/counseling by teachers or guest lecturers and remote assessments of their assignments to students, remote copy checking for assignments/ tests/ examinations by any parent/teacher/guest/alumni is also enabled by the system.

The system comprehensively enables remote updation of the changes in the software; upgradations of the software, bugs correction and integrates all the administrative, learning, other information, reports and analysis around every student on to one screen with hyper links for access by parents, teachers, principals, authorized others.

The integration includes such as but not limited to all the planned information of a section, class, or a defined group of students into a ‘one screen’ report with hyperlinks for teachers, principals, authorized others, along with all the planned information for the principal or administrators about all the teachers, staff on to ‘one screen’ reports with hyperlinks.

The system has in-built zones of control for students with respect to the time period of the timetable, level of the class, gender, special interests/rights and any violation of the same is reported automatically to the concerned teacher or staff.

The system adequately facilitates parents (or others in the family) with tools and resources that enhance their ability to most effective complement the inputs and counseling gained in the schools.

The invention is described in detail with reference to the example given below which are provided to illustrate the invention and therefore, should not be construed to limit the scope of the invention.

### EXAMPLE 1

A school in a remote small village may just have a facilitator who is not exactly qualified or trained as a teacher but uses the online processes and resources of this invention. The facilitator will be trained in handling this system to ‘teach’ all the relevant subjects to the enrolled students up to a level of classes that he/she is comfortable with. The students can also conduct all the experiments online. The attendance of the teachers and students could be measured in fairly fool-proof manner (if necessary; using biometric tools attached with the system or camera) so as to reflect any unwanted/unreported absence of students and teachers and other staff.

### EXAMPLE 2

A group of teachers (for instance, one teacher each from 5-7 different subjects) can actually establish a small but complete K-12 (or a large part of it) school using the online processes and resources of this invention. Further, using the self-tutoring and self-coaching tools of this invention, a set of people can actually create a world-class school at any location/within any community by just organising the basic physical infrastructure of a school such as classrooms with seating and PC and projection and the Internet. These teachers could also secure remote assistance/support from any other authorized user of the system, for their own queries or knowledge as well as for getting analytical feedback and compensating inputs for students based on the mining of extensive record of student input/responses in the system (in live or later mode).

### EXAMPLE 3

The institutional process framework could be best illustrated in terms of a day in the life of a student, teacher, principal/other departmental heads, parents, others. The connection with the school begins with the student boarding the school bus (or later when a student enters the school premises) and the school acknowledging the presence of the student in the school bus through a pull update on the school portal or a push message on any I.P. device/dedicated communication network such as mobile phones with the parents e.g. IPTV, mobile phones. The bus conductor/driver also gets an update on the children on board with any missing or late boarding at any instant. Students coming to the school in their own vehicles get registered upon entering the school gate just the way it does for those boarding the school bus. In the course of the day, the presence of the students in a class or any other assigned place is automatically registered, in the class rooms their interactions/responses are automatically recorded for the purposes of live interaction in the class using laptops, PDAs or similar IP-enabled devices and similarly any access or payment to be done by students is also automatically authenticated.

### EXAMPLE 4

A day in the school for the teacher starts with attendance at the school gate and/or in the school bus the same way as the students. Teachers' presence inside a class or designated facility is continuous and automatically registered. The entire period of the teachers is spent on mostly bottom-up and lateral discussions with students and the top-down agenda based on the analytical reports of the students performance on the self-diagnosing/self-checking platform which the teachers study before starting each of their class. Outside the classrooms there would be very limited ‘copy checking’ or assignment creation or notes making, time tabling or all such currently physical activities as all these are automated and teachers spend time carefully studying the various analytical reports or communicating with parents or students. The classroom content for instruction is digitally available and updated every quarter or such period.. Interaction with head of departments or principals or other administrative staff can also be backed up by analytical reports generated by the system and fairly well defined and informed agenda. Even the additional reading/reference materials and assignments (questions, games, projects etc.) to be used in classrooms or to be assigned to the students for homework are all part of the system (of course the teachers can add/modify the bank of assignments or reading materials) and teacher can specifically or randomly select and assign the appropriate level of assignments or reading materials to the students by a few clicks or choices in the system.

### EXAMPLE 5

A day in the life of a parent begins with dropping the children at the school gate or the bus stop and being able to track their movement on demand or on request and in the mode wanted—video, text, coordinates etc. The parents can anytime log-in and see the screen of the ‘computer’ of their children from their home or office or elsewhere to see the micro-progress of the children during the day. Of course, they can also see various analytical reports on the past performances/misses of the children at the click of a button on their laptop, PDA, any such device on the IP. All their online educational activities at home also get reported similarly.

### EXAMPLE 6

A day in the life of a principal or an administrator begins with being able to track the live status of attendance of all concerned at will or on request and in the mode Wanted that is video, text, coordinates etc. They can anytime log-in and see the screen of the ‘computer’ of the students from their home or office or elsewhere to see the micro-progress of any child or a group of students during the day. Of course, they can also see various analytical reports on the past performances/misses of the students in a class, a section, or any group of students or with respect to the students of a teacher or the teachers of a department or group of classes/section at the click of a button on their laptop, PDA, any such device on the IP. All their online educational activities at home also get reported similarly.

### EXAMPLE 7

The students will get their homework/assignment in a subject like Math and Science from school on the system and they will ‘do’ the homework online, step-by-step in most cases, which will be checked instantly and reported to the student. There will be no need for copy-checking for the teachers and they will get multifaceted reports on the ‘answer submissions’ by students.

### EXAMPLE 8

The students will get their homework/assignments for subjects like languages and social sciences from school on the system and they will ‘do’ the homework online. Their answers will be checked online, to a great extent (grammar and substance), and they will be reported of their gross mistakes instantly and teachers will get multifaceted reports on the ‘answer submissions’ by students. There will be ‘online copy-checking’ for only those assignments and students in which case the teachers feel the need to go beyond the obvious gross mistakes and bring out the finer nuances of the answer submissions.

### EXAMPLE 9

The students can also input numerical question from math and science book being used by him/her and solve them step by step. This facility is available for the vast majority of the questions till class XII (typical exceptions include 3-Dimension objects.

### EXAMPLE 10

While a student is working on his/her homework or any other numerical question from the books used, his/her parent/tutor/school teacher/friend/peer/any other authorized student or person can log in from their own identity and view the attempts/inputs being made by him/her to solve the numerical questions. He/she could be effectively guided live at that moment (or later also) in solving the question by the parent/tutor/school teacher/friend/any other authorized student or person.

### EXAMPLE 11

At any point a student can revise the topics across chapters in which he/she has previously tested herself on the system. The system simplifies the effort and time of revision by only presenting those questions which were once or multiple times wrongly responded by him/her (after testing any set of topics for the first time, the ‘Revise’ option throws up the wrong responses/answers and student can re-assess self only on the wrong answers/responses of the first time; and this creates the second layer of ‘Revision’ content. In fact, it allows multiple level of revision by allowing a student to be focused first on questions which were most repeatedly answered wrong, then those which were less repeatedly answered wrong in a hierarchical manner. The system is somewhat intelligent to suggest topics/chapters which need most attention in revision.

### EXAMPLE 12

SMS is a viable medium for teachers to set up exam papers online in a way that the student's responses to tests will be checked upon their sending SMS. The teacher, once authorised to do so, can just send one SMS to the system to set up the exam paper against which the students (who are the target audience) will send in the response SMS and get their score in return SMS. The students can also send further SMS to get the details of their exam paper performance—the right answers, wrong answers, reasons for wrong answers and such other details in reply SMS as per the request in the SMS. Of course the teachers can also upload the papers online and that significantly enhances the specificity of the performance analysis of the students available through SMS or online (the SMS and the online platform are seamlessly integrated).

### EXAMPLE 13

In some instances the students are enabled (it could be enabled for all testing if necessary) to respond/ answer to assessments/tests through SMS and get their result through SMS. In this case the tests can be available on paper or offline on a computer or online on the portal.

### EXAMPLE 14

Different subjects have different interface for diagnostic assessment on the subject. For instance, in Biology, the students are offered visual diagnostic over and above the conventional diagnostic assessments. In the visual diagnostics, there are various components.

Chemistry, for example has three interfaces—inorganic, organic and physical—and the system checks the response to the questions defined by the student or generated by the system for all the possible mistakes in writing a chemical equation at their curricular level. The inorganic diagnostic interface enables students to test knowledge on all aspects (e.g. conditions, reactants, products) of chemical equations in their curriculum (including balancing equations, completing partial equations) in organic chemistry. The organic interface enables students to test their understanding of structure of organic compounds and attempts to tell them of similar looking compounds. In the physical chemistry interface, the numerical question are selected from a bank of questions and solved step by step in semi-intelligent system.

Physics on the other hand, is kind of a mix of Biology and Chemistry—it has Biology-like visual diagnostics and Chemistry like numerical question interface.

To top it, for each student, in all of the above diagnostics, the teachers, tutors, parents or any other authorized person can view the entire set of choices made by him/her while working on the diagnostic assessments, in the ‘live mode’ (while the student is working on the diagnostic assessment on the system from his/her computer) or ‘later mode’ (after the student has moved out of a diagnostics) and support the student appropriately (for instance, in the live mode, by getting into a chat mode and in the later mode send in a note, additional readings, solution etc.)

### EXAMPLE 15

A student in accountancy and taxation can choose a numerical question from the bank of questions in the system and make step by step entries of his/her solution. The system will indicate the broad reasons for why his/her entries may be wrong (e.g. “Are you sure the account head is correct”, ‘Are you sure it's a credit transaction’, ‘Are you sure the amount is right’) and on demand also shows the right entries. And to make it user friendly there is option for ‘Long method’ (the user has to enter each accounting transaction) and ‘short method’ (the user gets to view the answer with some terms missing and the user has to fill-in the missing terms). The students also have the option of entering their questions in to the system for many of the numerical questions (such as accountancy questions which have ledger accounts or higher accounts such as trial balance as the inputs available in the question) and then the system assists them in solving the questions step-by-step as detailed above. In this way students of accountancy and taxation become uniquely self-learners. This part of the system also enables individuals or small organisations to undertake financial or investment analysis by inputting their financial data into the system.

While a student is working on the e-Accountancy platform, an authorized person (such as a tutor, a practicing accountant, another student) can log-in and view the entries by the student, live or later, and suggest.

### EXAMPLE 16

A family can create a ‘virtual’ school of their own, in their own brand name and register children from the neighbourhood or extended kinship, friendship. The system provides the family with the option of seeking answers to their queries for the subjects taught at the school from a bank of experts working on the system on a free-lance: or employment or volunteering basis. In a similar way, organizations or the employees of an organization (spread all across the world) can create their own learning and community portal for use by their family members or other specifically included families (enrolled for corporate CSR or families of the vendors or partners or buyers). The system also enables the family members in the community (e.g. non-working spouses of the employees) to offer their services (learning or others and at a price or voluntary) to all others with the community or even outside the community.

### EXAMPLE 17

A school can take step-wise integration of I.T. such as just automating the key parent interface such as notice of absence from school at roll call in class, notices and circulars, report of performance in tests/assessments, listing of assignments/homework, important messages/remarks from parents. In due course, it can extend to report absence of a child from boarding the bus at the designated bus stop. Again, this could be auto-generated (using hardware biometric devices on board the bus and on person of the students) or triggered by some human intervention (e.g. the bus conductor). Similarly, the attendance in class or library or labs can be automated or triggered by the teachers.

### EXAMPLE 18

A teacher, tutor, parent or any other authorized person can find out the topics/subjects/ assessments which a student is not following up at home e.g. it may easily be reported that a particular student has not read or revised or attempted tests/assessments in trigonometry in the past 9 weeks! This becomes very potent information at the hands of all the stakeholders and they can help students in a far focused and supportive manner at home as well as school. The home and school environments fuse to create a seamless experience for the children.

### EXAMPLE 19

The system offers independent testing/, assessments that blunt the possible biases in a teachers' approach towards a student of a group of students e.g. if a teacher repeatedly grades a student lower than rightfully entitled but the tests/assessments on the system consistently get him/her a higher score, the student may not read too much into the teachers' grades and continue to feel good about his/her academic growth. The system .provides multiple layers and options for relative benchmarking (e.g. percentile score) of performance of students and together with absolute benchmarking details (e.g. percentage marks) of the various tests, assignments, diagnostics, interactions in the classrooms, the students also get uniquely precise inputs for time, focus (on subjects and topics) and effort while preparing for competitive examinations (where the relative benchmarking prevails).

### EXAMPLE 20

The entire system is uniquely integrated to provide ‘one window’ access to all the details, present and past, of students (even alumni) from all inputs and interactions of the students at school or home or the inputs by the teachers, parents, peers, principals, other staff, or other authorized persons w.r.t. to a student.

Numerous modifications and adaptations of the system of the present invention will be apparent to those skilled in the art, and thus it is intended by the appended claims to cover all such modifications and adaptations which fall within the true spirit and scope of this invention.

1-20. (canceled)

21. A learning system for digitalization of an education institution comprising:
a digital identification system server and nodes in an intranet in the institution;
an internet-based server and bandwidth infrastructure for delivering computer infrastructure as a platform virtualization environment; and
access devices and identify assurance and management system for ensuring automated attendance/presence of students, teachers, staff and/or guest visitors and for mapping a student identity to the institution intranet and an internet based portal of the institution.

22. The system as claimed in claim 21, wherein means for integrating multi-format learning and education into routine personal and professional lives for self tutoring, self checking or diagnostic test bed, subject learning system and tracking the progress of the students are provided with the help of identify assurance and management system for providing comprehensive insight into a complete learning context of the students while in the institution and/or at home.

23. The system as claimed in claim 21, wherein a self-tutoring, interactive learning tool is provided for focusing on K-12 students as well as teachers and parents, said tool customized such that the content is tailored for books used by the students, covering an entire K-12 curriculum, based on multiple formats and administrative software tools on the system.

24. The system as claimed in claim 21, wherein said system is based on real identifies for the institution and wherein database of each institution is populated only by authorized users of the institution.

25. The system as claimed in claim 21, wherein said system is provided with hardware for identification using user ID and password, with or without any biometric device, any computer cloud for online hosting any database (RDBMS) server for database storage using internet as a backbone for communication.

26. The system as claimed in claim 21, wherein said system is adapted for providing online presence/space to various departments of the institution where department specific data can be uploaded and shared online.

27. The system as claimed in claim 21, wherein said system is adapted for providing online collaboration from peers, teachers, parents, tutors and other authorized users of the system and for providing in-person classroom interactions and interactions beyond the class but in the institution.

28. The system as claimed in claim 21, wherein the system is adapted for digitalizing all processes of the institution, including administrative, learning, admission, alumni, filings/reports for governments, alumni relations, inter-school exchanges, intra-society/government department exchanges and reporting online or offline.

29. The system as claimed in claim 28, wherein said digitalization includes syllabus, class notes, assignments, examination papers, progress reports, listings, notices, and/or fees.

30. The system as claimed in claim 28, wherein said system is further adapted for digitalizing all routine processes of the teacher that include copy checking for assignments beyond objective-type questions, communication with parents and colleagues, notices, event planning and management, progress reporting, syllabus, timetabling, class room lecture content and notes, and queries from students and parents.

31. The system as claimed in claim 21, wherein said system is further adapted for digitalizing all routine processes for the student that include notifying presence or absence at any instant of time or place student related credit/payment systems, automated response/input registration of students to the various academic transactions in the school or home, class notes and lectures, homework and its submission upon completion, access to various facilities in the school, availing of the various services in the school.

32. The system as claimed in claim 21, wherein said system is adapted for helping the staff by digitalizing all routine processes for the staff that include accounts, library fees, payroll, book shop, hostel, mess, reception/front office, storing data in a local database and generating a summary to send it to online database for further communication.

33. The system as claimed in claim 21, wherein said system is adapted for tracking the student's physical presence/activity by using an RFID device.

34. The system as claimed in claim 21, wherein said system is adapted for full control of the student's access and usage of devices in the classrooms, a teacher's ability to see the snapshot of the screen and keys/mouse/any other inputs of the students while conducting the classes, a teacher's ability to push assessments for students and see its detailed live reporting on a device, a teacher's ability to control the access to various resources on the net or intranet for the class as a whole or a subset.

35. The system as claimed in claim 21, wherein said system is further adapted for benefiting the principal or head of the institution from the digitalized routine processes that include MIS on administrative status and approvals, MIS of learning related status and approvals for each student, analytical reports on teacher and staff performance, query and interactions with parents and others.

36. The system as claimed in claim 21, wherein said system is further adapted for digitalizing all routine processes of an alumnus and visitors that include registration, exchange with teachers, students or other alumni, community services, business links, product promotions, access rights, record of interactions/exchanges, evaluation of exchange/contributions, and communications/notices.

37. The system as claimed in claim 21, wherein said system is adapted for digitalizing routine processes and content for access of media, including Text SMS, Multi-media SMS, remote live video, PDA integration, and/or GPS.

38. The system as claimed in claim 21, wherein said system is preferably wireless, biometric and RFID integrated and said system is provided with in-built zones of control for students with respect to the time period of the timetable, level of the class, gender, special interests/rights and any violation of the same is reported automatically to the concerned teacher or staff.

39. The system as claimed in claim 21, wherein a digital platform is provided for enabling interactions and exchanges between the formal, informal and private learning communities for educational and social and economic purposes.

40. The system as claimed in claim 39, wherein said digital platform is driven primarily on real identity of people that is current at any given point in time.
